(19) United States
(12) Patent Application Publication
(10) Pub. No.: US 2019/0128438 A1
(43) Pub. Date: May 2, 2019

(54) A VENT APPARATUS AND A METHOD THEREOF

(71) Applicant: TRITON VALVES LIMITED, Bangalore (IN)

(72) Inventors: S MALLIKARJUNAIAH, Bangalore (IN); Mihir BAJEKAL, Bangalore (IN); Arun NAGARAJAN, Bangalore (IN); Prathap KAMATH, Bangalore (IN); Van T WALWORTH, Bangalore (IN)

(73) Assignee: TRITON VALVES LIMITED, Bangalore (IN)

(21) Appl. No.: 16/095,639

(22) PCT Filed: Apr. 28, 2017
(86) PCT No.: PCT/IN2017/050152

§ 371 Date: Oct. 22, 2018

(30) Foreign Application Priority Data
Apr. 29, 2016 (IN) 201641015095

(51) Int. Cl. F16K 24/04; B29C 33/10

(52) U.S. Cl. CPC F16K 24/04; B29C 33/10

(57) ABSTRACT

A vent apparatus (100) includes a housing (102), a plunger (104) and a biasing mechanism (104). The plunger (104) has a first portion (104a), a second portion (104b) and a stem portion (104s) connecting the first portion (104a) and the second portion (104b). Further, a neck portion (104n) is provided near the second portion (104b). The biasing mechanism (104) is adapted to move the plunger (104) from an open position, where the first portion (104a) of the plunger (104) is at least partially away from the housing (102), and a closed position, where the first portion (104a) is entirely received inside the housing (102).

### CROSS REFERENCE TO RELATED APPLICATION

The present application is based on, and claims priority from, Indian provisional application number 201641015095 filed on Apr. 29, 2016, the disclosure of which is hereby incorporated by reference herein.

### TECHNICAL FIELD

The embodiments herein relate to a vent apparatus and, more particularly, but not exclusively to a vent apparatus that is adapted to be provided in a conduit between at least two interconnected volumes of space.

### BACKGROUND

Generally, in certain applications, a vent apparatus that provides selective permeability to predetermined substance is usually desired. For example, in vulcanization process, a vent apparatus is required to be provided in the mold for venting out air and other gases thereby limiting formation of unwanted depressions and projections on the product. Similarly, in thermoplastic molding process, such vent apparatuses are required to be provided for venting out gases and other predetermined substances having low viscosity. Further, in medical applications, where a patient has to be provided with medicine in the form of vapor or the like from a containment reservoir which receives medicine in the form of fluid, a vent apparatus is required to allow the less viscous substance to pass through thereof and prevent the high viscous substance from passing through.

Conventional mechanical vent apparatuses include a valve which provides a one way flow of the fluid and hence cannot be effectively used for the aforementioned applications. For example, in vulcanization process, a conventional one way flow vent apparatus will result in a vacuum lock being created in the mold and poses difficulty in removing the mold after completion of the process. Further, some conventional vent apparatuses for vulcanization process, include a housing and a plunger element received entirely inside the housing for allowing passage of certain substances. However, such vent apparatuses often employ a split-type plunger and when provided in the mold, makes it difficult for a technician to be able to access the plunger for the purposes of repair and removal. In addition, the aforementioned conventional vent apparatuses have complex design with significant operational issues thereby increasing the cost of manufacturing and maintenance. Further, the housing of such conventional vent apparatuses include spreading collar which results in requiring excessive force to seat and/or retract the plunger.

Further, conventional mechanical valves, due do their structural properties and configuration, may not be efficiently configured to be selectively permeable. Further, some conventional mechanical valves are usually constructed to be in a closed position during installation and therefore, may not suit the aforementioned applications. Using a conventional mechanical valve for the aforementioned applications and the like may prove to be tedious and time consuming during installation and, some conventional mechanical valves do not provide repair options thereto in the event of clogging or the like.

Therefore, there is a need for a vent apparatus that obviates the aforementioned drawbacks.

### OBJECTIVES

A principal objective of an embodiment of the present invention is to provide a vent apparatus which is selectively permeable to a predetermined substance.

Another objective of an embodiment of the present invention is to provide a vent apparatus which provides two way flow of a predetermined substance.

Yet another objective of an embodiment of the present invention is to provide a vent apparatus that is in an open position during installation.

Yet another objective of an embodiment of the present invention is to provide a vent apparatus that allows the relatively lower viscous material to permeate in one direction and also permeate back into a housing in another direction.

Yet another objective of an embodiment of the present invention is to provide a vent apparatus that prevents vacuum lock and associated drawback in a mold.

Yet another objective of an embodiment of the present invention is to provide a method for installing a vent apparatus.

These and other objectives of the embodiments herein will be better appreciated and understood when considered in conjunction with the following description and the accompanying drawings. It should be understood, however, that the following description, while indicating embodiments and numerous specific details thereof, are given by way of illustration and not of limitation. Many changes and modifications may be made within the scope of the embodiments herein without departing from the spirit thereof, and the scope herein include all such modifications.

### BRIEF DESCRIPTION OF THE DRAWINGS

The embodiments herein will be better understood from the following detailed description with reference to the drawings, in which:

FIG. 1 is a sectional view of the vent apparatus according to an embodiment as disclosed herein;

FIG. 2 shows a plunger and a housing of the vent apparatus according to an embodiment as disclosed herein;

FIG. 3 is a sectional view of the vent apparatus having a biasing mechanism disposed outside the housing thereof, according to an embodiment as disclosed herein;

FIG. 4 is a sectional view of the vent apparatus provided with an electromagnet, according to an embodiment as disclosed herein;

FIG. 5 is a sectional view of the vent apparatus according to another embodiment as disclosed herein;

FIG. 6 is a sectional view of the vent apparatus according to yet another embodiment as disclosed herein;

FIG. 7 is a top view of the vent apparatus according to yet another embodiment as disclosed herein;

FIG. 8 shows a sectional view of the vent apparatus according to another embodiment as disclosed herein;

FIG. 9 is a sectional view of the vent apparatus according to another embodiment as disclosed herein;

FIG. 10 is a sectional view of the vent apparatus according to yet another embodiment as disclosed herein; and

FIGS. 11a, 1 lb and 11c show a method of installing the vent apparatus in rubber molding process.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

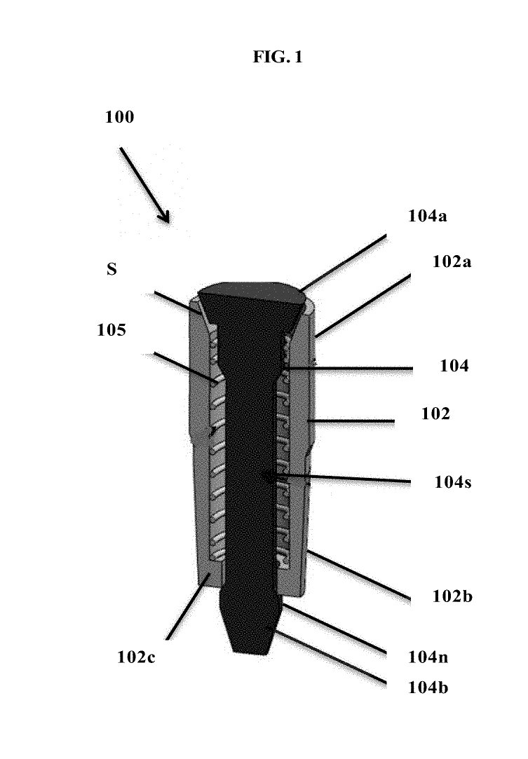

The embodiments herein disclose a venting apparatus and a method thereof. Referring now to the drawings, and more particularly to FIGS. 1 through 8d, where similar reference characters denote corresponding features consistently throughout the figures, there are shown embodiments.

FIG. 1 is a sectional view of the vent apparatus 100 according to an embodiment. The vent apparatus 100 includes a housing 102, a plunger 104 and a biasing mechanism 105. The housing 102 includes a first portion 102a defining an opening, a second portion 102b defining an opening opposite to the opening defined by the first portion 102a and a collar 102c. Further, the plunger 104 has a first portion 104a, a second portion 104b and a stem 104s connecting the first portion 104a and second portion 104b. The first portion 104a of the plunger 104 is relatively wider than the second portion 104b. The plunger 104 further includes a neck portion 104n near the second portion 104b.

The housing 102 of the vent apparatus 100 is adapted to receive a biasing member 105 between the first portion 102a and the second portion 102b. The housing 102 is further adapted to receive a portion of plunger 104 therein. The first portion 102a of the housing 102 defines a seat S having shape configured to receive the first portion 104a of the plunger 104.

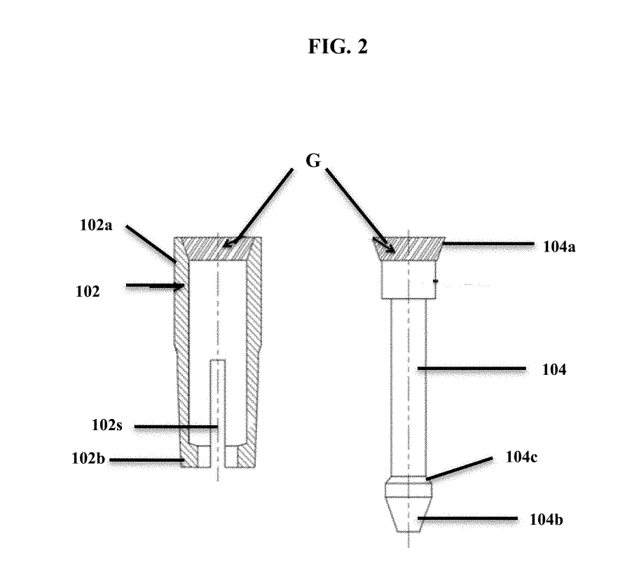

In an embodiment, the housing 102 is a hollow cylindrical member. The seat S defined by the first portion 102a of the housing 102 is a funnel shape and has an outer diameter greater than a diameter of the opening defined by the second portion 102b of the housing 102. A shape of the first portion 104a of the plunger corresponds to the shape of the seat S and the first portion 104b of the plunger 104 is configured to be received on the seat S. The plunger 104 is a circular solid member having a varying diameter and is configured to be received inside the housing 102 concentrically. The neck portion 104n of the plunger 104 has a diameter greater than a diameter of the stem 104s. The biasing mechanism 105 is a biasing element which is circular in shape and is received, in its entirety, inside the housing 102. The diameter of the biasing element is greater than the diameter of the stem 104s of the plunger 104. In an embodiment, the biasing mechanism 105 is a metal spring. However, it is also within the scope of this invention to have the biasing element made of any other material such as elastic, polymer or a combination thereof without otherwise deterring the intended function of the biasing mechanism 105 as can be deduced from this description. The neck portion 104n of the plunger 104 is adapted to engage the collar 102c of the housing thereby locking a further movement of the plunger 104 towards the seat S of the housing 102. The second portion 102b of the housing 102 defines at least one opening 102s (as shown in FIG. 2) on an outer surface, in a plane transverse to the collar 102c, of the housing 102. In an embodiment, opening 102s is a longitudinal slot. It is also within the scope of this invention to have the second portion 102b of the housing 102 define a plurality of openings having different shapes with different sizes.

In the aforementioned paragraph and at certain instances in this description, for the ease of understanding and explanation, the shape of vent apparatus 100 and thereby, the shape of the housing 102, the plunger 104 and the biasing element is considered as circular. However, it is also within the scope of this invention to provide the housing 102, the plunger 104 and the biasing element with different shapes such as square, rectangle and so on without otherwise deterring the intended function of the vent apparatus 100 as can be deduced from this description.

FIG. 2 shows a plunger 104 and a housing 102 of the vent apparatus 100 according to an embodiment. The first portion 104a of the plunger 104 defines a plurality of grooves G on the circumference thereof. The grooves G are adapted to allow a passage of predetermined substance such as air or other gases, near the first portion 102a of the housing 102 to second portion 102b of the housing and release the same via slots 102s.

Referring to FIG. 1 in combination with FIG. 2, an included angle of a first surface 104c defined by the neck portion 104n is greater than an included angle of a second surface defined by the second portion 104b of the plunger 104. In an embodiment, the included angle of the second surface defined by the second portion 104b is in the range of about 19°-62°. In another embodiment, the included angle of the second surface defined by the second portion 104b is 40°.

In another embodiment, the included angle of the first surface 104c is in the range of 101°-164°. In a further embodiment, the included angle of the first surface 104c is 140°.

As noted the tolerance of the included angle on surface 104b as mentioned above, has been found to benefit from being a tighter tolerance than the tolerance for the included angle of surface 104c. This is because the insertion force of plunger 104 into housing 102 must be controlled with precision and consistency for performance of the valve. The removal force required to extract plunger 104 from housing 102 does not require the level of precision since the plunger will be replaced accordingly with a new plunger 104.

In an embodiment, the second portion 102b of the housing 102 is tapered on the outside diameter. First portion 102a has a predominately straight outside diameter sized to provide a slight interference fit with a drilled hole in a mold application. Further, second portion 102b has reduced outside diameter avoiding an interference fit in the drilled hole of a mold application. Second portion 102b is further axially tapered toward collar 102c.

In an embodiment, the tapered included angle of second portion 102b is in the range of 2.5°-11° In an embodiment, the tapered included angle of second portion 102b is 5°. In an embodiment, the outside diameter of the second portion 102b of the housing is between 9%-21% less than the outside diameter of first portion 102a. Further, in an embodiment, the outside diameter of the second portion 102b is 15% less than the outside diameter of first portion 102a. During insertion of plunger 104, surface 104b will be forced through collar 102c resulting in second portion 102b to spread radially outward which will be facilitated by longitudinal slot 102s.

The combination of the length of longitudinal slot 102s cooperating with the outside diameter of second portion 102b at collar 102c will expand to allow plunger neck portion 104n to pass through without letting the expanded outside diameter surface of second portion 102c ground out or touch the inside diameter wall surface of the drilled hole in which housing 102 is assembled.

Further, an axial length of the longitudinal slot 102s is between 38%-53% of the overall length of housing 102. In an embodiment, an axial length of the longitudinal slot 102s is 45% of the overall length of housing 102.

Combining the features of longitudinal slot 102s with the features of second portion 102b and plunger surfaces 104b and 104c there is a difference in insertion kilogram force on plunger 104 into housing 102 compared to the extraction kilogram force of plunger 104 from housing 102. Insertion kilogram force is in the range of 2.5-6.3 kgf. In an embodiment, the insertion kilogram force is between 4-5 kgf.

In contrast, extraction kilogram force of plunger 104 from housing 102 is in the range of 8.5-15.7 kgf. In an embodiment, the extraction kilogram force of between 11-13 kgf.

Further, in an embodiment, the housing 102 and the plunger 104 of the vent apparatus 100 share a frictional interface fit.

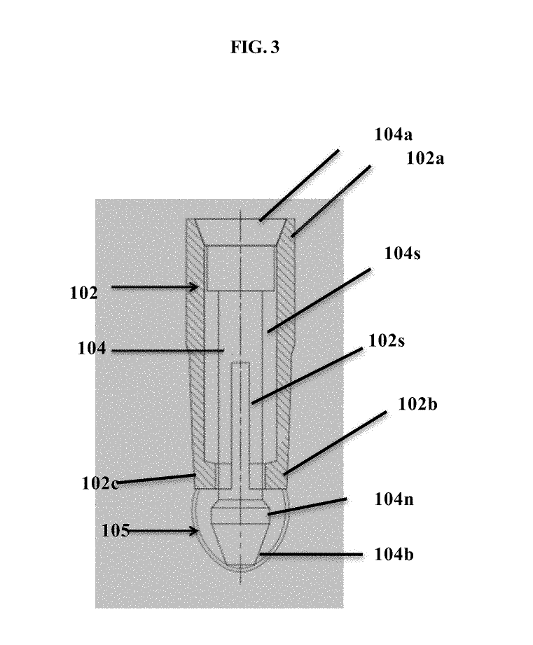

FIG. 3 is a sectional view of the vent apparatus 100. According to the embodiment as shown in FIG. 3, the vent apparatus 100 includes a biasing mechanism 105 disposed outside the housing 102. Specifically, the biasing mechanism 105 is biasing element disposed outside the second portion 102b of the housing 102. The second portion 104b of the plunger 104 is adapted to be constantly in direct contact with the biasing element. The biasing mechanism 105 is configured to push the second portion 104b of the plunger 104 away from the first portion 102a of the housing 102. In the embodiment as shown in FIG. 3, the biasing mechanism 105 is an elastic material. However, it is also within the scope of this invention to provide a biasing mechanism 105 made of polymer, metal or the like, without otherwise deterring the intended function of the biasing mechanism 105 as can be deuced from this description.

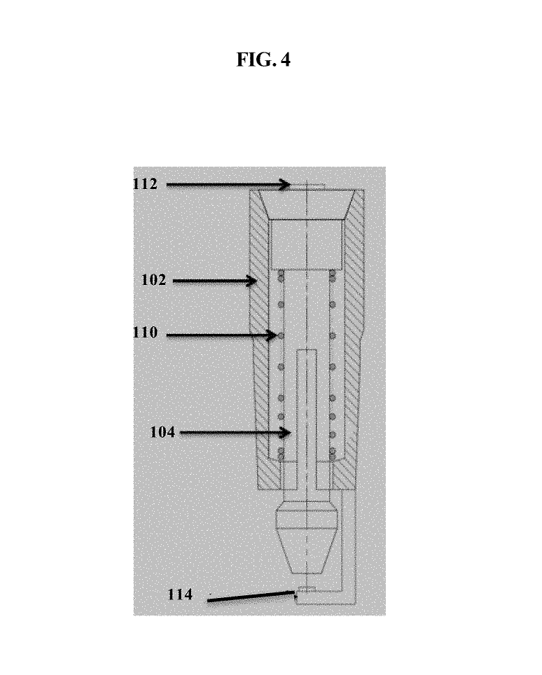

FIG. 4 is a sectional view of the vent apparatus 100. The embodiment as shown in FIG. 4 further includes a biasing mechanism 105 having a spring 110, a sensor 110 and an electromagnet 112. The spring 110s is disposed inside the housing 102. The electromagnet 112 is disposed outside the housing 102 and near the second portion 102b of the housing 102. The sensor 110 is provided on the first portion 104a of the plunger 104. In an embodiment, the sensor 110 is at least one of a proximity sensor and a touch sensor. The plunger 104 is made of a suitable magnetic material. In operation, when the vent apparatus 100 is in the open position, where the polarity of the electromagnet 112 and the first portion 104a of the plunger 104 is the same thereby repelling each other, the first portion 104a of the plunger 104 is disposed away from the seat S of the housing 102. The air and other gases are allowed to pass through the housing 102. As and when the material in the mold contacts the sensor 110, the polarity of the electromagnet is changed thereby attracting the second portion 104b of the plunger 104, the first portion 104a of the plunger 104 moves closer to the seat S of the housing 102 and seals the passage of air and other gases. While in the aforementioned embodiment of paragraph [0030] and the corresponding FIG. 4, it is mentioned that spring 110s is present, it is also within the scope of this invention to have a vent apparatus 100 with a biasing mechanism 105 consisting only of the electromagnet 112 and the sensor 110.

In the aforementioned embodiments of FIGS. 1 through 4, it should be noted that a length of the plunger 104 is greater than a length of the housing 102 thereby facilitating easy installation, removal and repair of the vent apparatus 100. Further, in the aforementioned embodiments of FIGS. 1 through 4, a combined length of said first portion 104a and said neck portion 104s of said plunger 104 is at least one of equal to and greater than a length of an entirety of said housing 102.

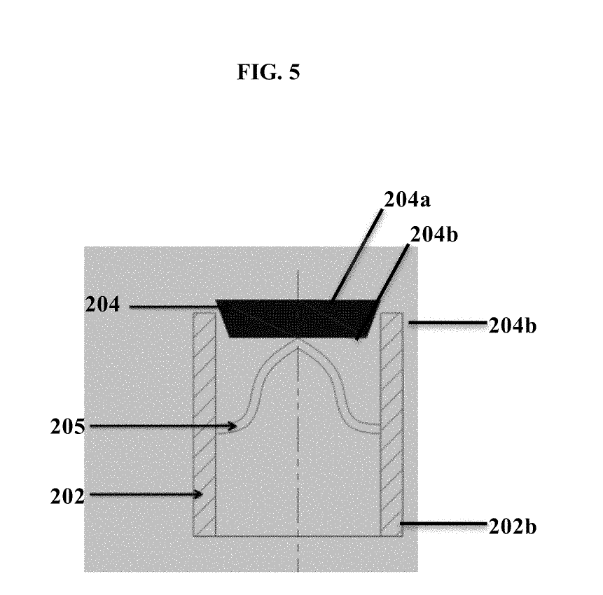

FIG. 5 is a sectional view of the vent apparatus 200 according to another embodiment. The vent apparatus 200 includes a housing 200, a plunger 204 and a biasing mechanism 205. The housing 200 includes a first portion 202a, a second portion 202b located opposite to the first portion 202a and a middle portion 202m located in between the first portion 202a and the second portion 202b. The plunger 204 includes a first portion 204a and a second portion 204b. The biasing mechanism 205 extends from the middle portion 202m of the housing 202 towards the first portion 202a. The biasing mechanism 205 is at least one of an elastic material, a spring or the like. The biasing mechanism 205 is provided with a plurality of openings configured to allow passage of air or gas there through to the second portion 202b of the housing. The second portion 204b of the plunger 204 is adapted to be always disposed above the middle portion 202m of the housing 202. Further, the first portion 204a of the plunger 204 is, in closed position, is configured to engage the first portion 202a of the housing 202 thereby sealing the passage of any substance through the housing 202. In operation, when the vent apparatus 200 is provided in a mold, the plunger 204 is configured to be in open position, where the first portion 204a of the plunger 204 is away from the first portion of the housing 202a, thereby allowing air or the gas to move out of the mold and into the housing 202. As and when the other high viscous material in the mold pushes the plunger 204, the first portion 204a of the plunger moves towards the first portion 202a of the housing 202 and eventually seals the passage.

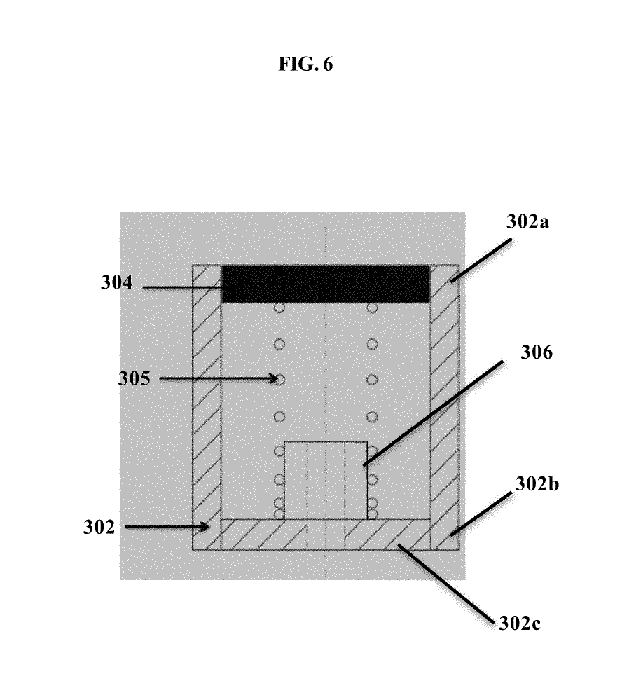

FIG. 6 is a sectional view of the vent apparatus 300 according to yet another embodiment. The vent apparatus 300 includes a housing 302, a disc 304, a spring 305 and a bush 306. The housing 302 includes a first portion 302a, a second portion 302b, and a collar 302c. The collar 302c defines an opening there through. The bush 306 is provided concentrically near the second portion 302b of the housing 302. The bush 306 is adapted to support the spring 305 and defines an opening in communication with the opening defined by the collar 302c. In operation, when the disc 304 is away from the first portion 302a of the housing, passage of air and gases are allowed through the housing 302.

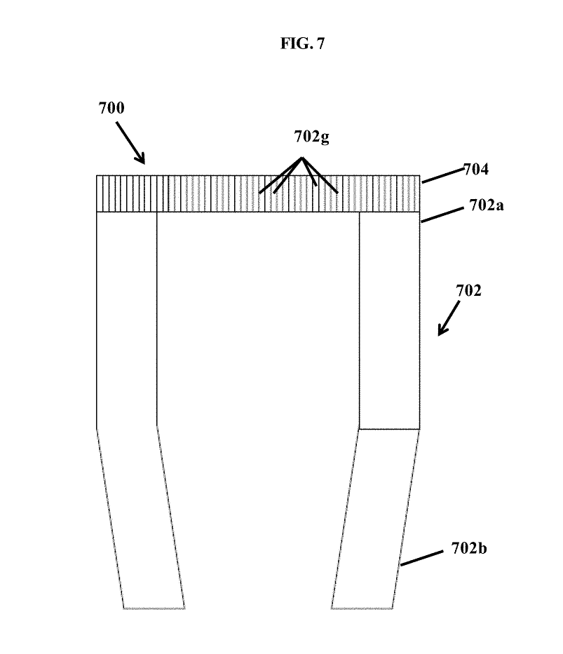

FIG. 7 is a top view of the vent apparatus 700 according to yet another embodiment. The vent apparatus 700 includes a housing 702 and a frame 704a with a mesh 702b defining a plurality of grids 702g. The housing 702 has a first portion 702a and a second portion 702b. The frame 704a is adapted to be provided near the first portion 702a of the housing 702. In an embodiment, the frame 704a is adapted to be received on top of the first portion 702a of the housing 702. It is also within the scope of this invention to provide the frame 704a inside the first portion 702a of the housing 702. Each of the grid 702g has a size in the range of 0.1 mm×0.1 mm to 0.3 mm×0.3 mm. In operation, the vent apparatus 700 is in an open position, thereby allowing a passage of air through the grids 702g while preventing a high viscous substance like rubber from escaping there through. It is also within the scope of this invention to provide the mesh 704b directly onto the first portion 702a of the housing 702.

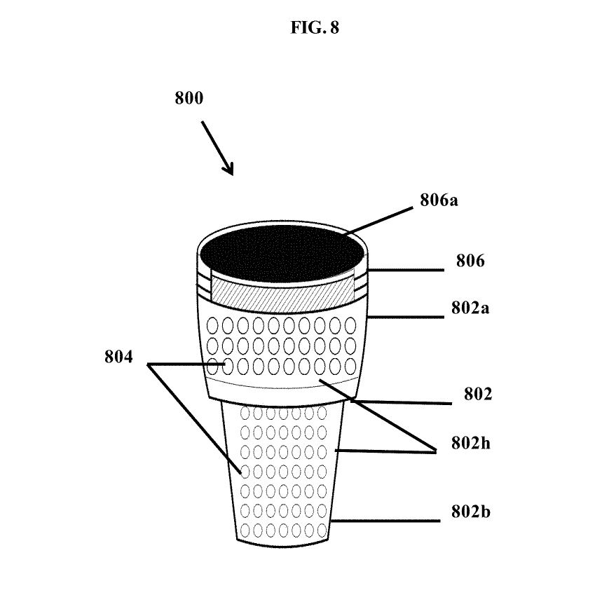

FIG. 8 shows a sectional view of the vent apparatus 800 according to another embodiment as disclosed herein. The vent apparatus 800 includes a housing 802, a cap 806 and at least one filler element 804. The housing 802 has a first portion 802a and a second portion 802b opposite to the first portion 802a. The housing 802 defines a hollow portion 802h configured to receive a plurality of filler elements 804 therein. In an embodiment, the housing 802 has a tapered cross-section between the first portion 802a and the second portion 802b. In an embodiment, the housing 802 defines a circular cross section with a diameter of the first portion 802a being greater than a diameter of the second portion 802b. In another embodiment, a width of the first portion 802a is greater than a width of the second portion 802b of the housing 802.

Further, the cap 806 is adapted to be secured to the housing 802 near the first portion 802a of the housing 802. The cap 806 includes a semi-permeable layer 806a configured to allow passage of air or gas there through. In an embodiment, the filler element 804 includes a plurality of metal balls. It is also within the scope of this invention to provide any of a wire mesh, metal pellets, non-metal pellets, non-circular metal or non-metal pieces and a combination thereof as filler element without otherwise deterring the intended function of the vent apparatus 800 as can be deduced from this description.

In operation, the vent apparatus 800 is in an open position, thereby allowing a passage of air through the semi-permeable layer 806a while limiting a movement of high viscous substance like rubber from escaping there through. The air or gas is then passed through the filler element 804 and out of the second portion 802b of the housing. Further, the filler element 804 provides sufficient backpressure to the substance having low viscosity. In an embodiment, the filler element 804 includes mutli-layered materials. For example, filler element 804 can include at least one layer of denser wire mesh provided with metal balls packed in the housing 802. The wire mesh provides sufficient porosity to allow passage of air or gas while restricting a movement of rubber molecules or other substances. In an embodiment, the wire mesh provided as a filler element 804 has a density in range of 90% to 99.98% and the corresponding porosity in the range of 0.02% to 10%. It is also within the scope of this invention to provide at least one longitudinal slot (not shown) near the second portion 802b of the housing for the air or gases to pass through.

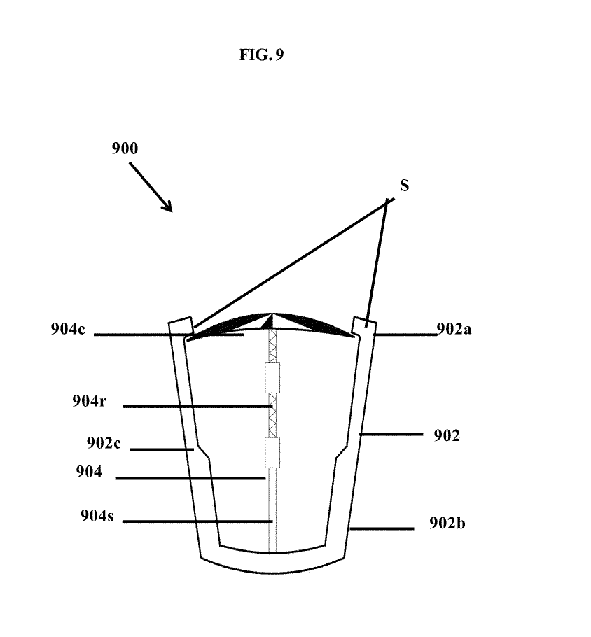

FIG. 9 is a sectional view of the vent apparatus 900 according to another embodiment as disclosed herein. The vent apparatus 900 includes a housing 902 and a biasing mechanism 904. The housing 902 has a first portion 902a, a second portion 902b opposite the first portion 902a and a collar portion 902c. The housing 902 defines a hollow portion 902h therein. The first portion 902a of the housing 902 defines a stopper S. In an embodiment, the housing 902 defines a tapered cross section between the first portion 902a and the second portion 902b.

Further, the biasing mechanism 904 includes a stem 904s, at least one spring 904r and a canopy 904c. The canopy 904c is moveably provided near the first portion 902a of the housing 902. The spring 904r along with the stem 904s is configured to move the canopy 904c between a first position, where the canopy 904c is near the stopper S, and a second position where the canopy 904c is near the collar 902c. In an embodiment, a width of the canopy 904c is less than an inner width of the first portion 902a of the housing and greater than an inner width of the second portion 902b of the housing 902.

In an embodiment, the second portion 902a of the housing defines at least one longitudinal slot (not shown) to allow passage of air or gas there through.

In operation, when the canopy 904c is in the first position, the air or gas is allowed to pass through a gap between the canopy 904c and the first portion 902a of the housing 902. Thereafter, as and when the high viscous material is in direct contact with the canopy 904c, the canopy 904c is pushed towards the collar 902c of the housing thereby allowing air or gas to pass through from the first portion 902a to the second portion 902b and then through the longitudinal slot. In an embodiment, the canopy 904c has a matt finish.

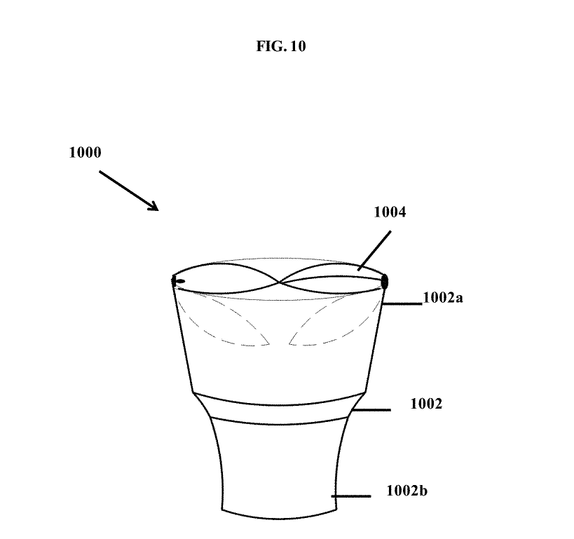

FIG. 10 is a sectional view of the vent apparatus 1000 according to yet another embodiment as disclosed herein. The vent apparatus 1000 includes a housing 1002 and at least one closure element 1004. The housing 1002 includes a first portion 1002a and a second portion 1002b opposite the first portion 1002a. The closure element 1004 is moveably connected to the first portion 1002a of the housing 1002. In an embodiment, the closure element 1004 is hingedly connected to the first portion 1002a of the housing 1002. In an embodiment, the closure element 1004 is a butterfly valve having two closure elements.

In operation, air or gas passes through the opening created when the closure element biased towards the second portion 1002b of the housing 1002. The air or gas is then allowed to pass through the second portion 1002b of the housing 1002.

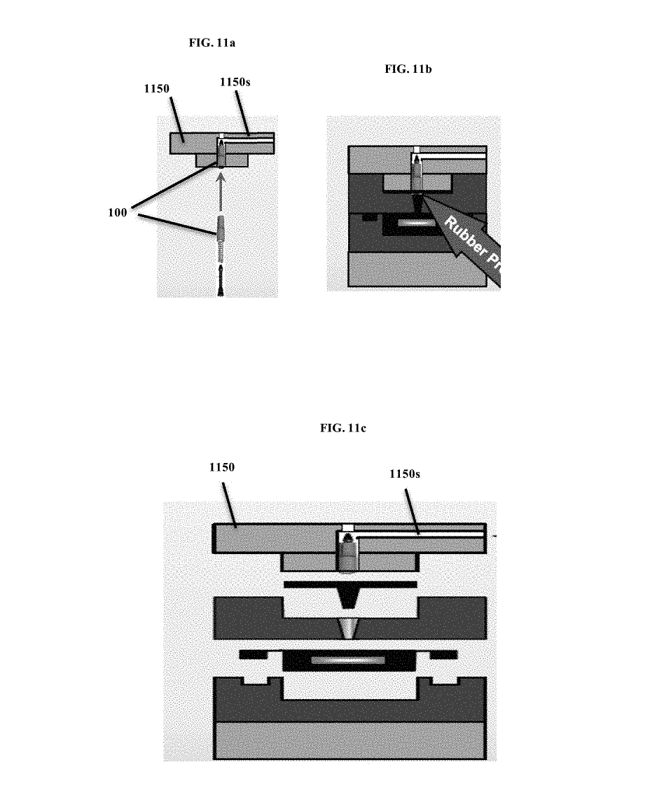

Further, a method of installing the vent apparatus is explained herein below with reference to FIGS. 11a, 11b and 11c. For the ease of understanding, vent apparatus 100 as described with respect to FIG. 1 and rubber molding application is considered. However, any of the vent apparatuses explained as embodiments in this description may be used in any similar applications without any modifications or with minor modifications within the spirit of this invention and such modifications are within the scope of this invention.

In operation, as shown in FIG. 11a, the vent apparatus 100 is provided inside the transfer pot 1150 used during the molding process. The transfer pot 1150 is provided with a slot 1150s for allowing passage of air. The vent apparatus 100 will be in the open position. When the molten rubber is provided inside the mold (as shown in FIG. 11b), air and other gases having less viscosity pass through the vent apparatus 100 and through the slot 1150s provided in the transfer pot 1150. When the mold is completely filled or filled up to a predetermined level with molten rubber, the plunger 104 of the vent apparatus 100 seals the passage of air and other gases. After completion of the molding process, air is passed through the slot 1150s of the transfer pot 1150 and through the vent apparatus 100 thereby eliminating the vacuum lock created inside the mold.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A vent apparatus (100), said apparatus (100) comprising:
a housing (102);
a plunger (104) having a first portion (104a), a second portion (104b) and a stem portion (104s) connecting the first portion (104a) and the second portion (104b), and a neck portion (104n) near said second portion (104b); and
a biasing mechanism (104), said mechanism (104) adapted to move said plunger (104) from an open position, where the first portion (104a) of the plunger (104) is at least partially away from said housing (102), and a closed position, where the first portion (104a) is entirely received inside said housing (102), wherein
a combined length of said first portion (104a), said stem portion (104s) and the neck portion (104n) of said plunger (104) is at least one of equal to and greater than a length of an entirety of said housing (102).

2. The vent apparatus (100) as claimed in claim 1, wherein
said housing (102) includes a first portion (102a) defining a first opening configured to accommodate said first portion (104a) of said plunger (104), a second portion (102b) and a collar (102c);
said collar (102c) is provided near said second portion (102b) and opposite to said first portion (102a) and defines an opening which is concentric to the first opening; and
said housing (102) defines at least one longitudinal slot (102s).

3. The vent apparatus (100) as claimed in claim 2, wherein said biasing mechanism (105) is provided inside said housing (102).

4. The vent apparatus (100) as claimed in claim 3, wherein said biasing mechanism (105) includes a spring having a diameter greater than a diameter of said stem (104s) of the plunger (104).

5. The vent apparatus (100) as claimed in claim 1, wherein said first portion (104a) of said plunger (104) defines a plurality of grooves (G).

6. The vent apparatus (100) as claimed in claim 5, wherein an included angle of a first surface (104c) defined by the neck portion (104n) is greater than an included angle of a second surface defined by the second portion (104b) of the plunger 104.

7. The vent apparatus (100) as claimed in claim 6, wherein the included angle of the second surface defined by the second portion (104b) is in the range of about 19°-62°.

8. The vent apparatus (100) as claimed in claim 7, wherein the included angle of the first surface (104c) is in the range of 101°-164°.

9. The vent apparatus (100) as claimed in claim 6, wherein the included angle of the second surface defined by the second portion (104b) is 40°.

10. The vent apparatus (100) as claimed in claim 9, wherein the included angle of the first surface (104c) is 140°.

11. The vent apparatus (100) as claimed in claim 2, wherein said second portion (102b) of said housing (102) defines a tapered outer diameter.

12. The vent apparatus (100) as claimed in claim 11, wherein a tapered included angle of said second portion (102b) of said housing (102) is in the range of 2.5°-11°.

13. The vent apparatus (100) as claimed in claim 12, wherein the outside diameter of the second portion (102b) of the housing (102) is between 9%-21% less than an outside diameter of the first portion (102a).

14. The vent apparatus as claimed in claim 11, wherein a tapered included angle of said second portion (102b) of said housing (102) is 5°.

15. The vent apparatus (100) as claimed in claim 14, wherein the outside diameter of the second portion 102b is 15% less than an outside diameter of first portion (102a).

16. The vent apparatus (100) as claimed in claim 2, wherein an axial length of the longitudinal slot (102s) between 38%-53% of an overall length of housing (102).

17. The vent apparatus (100) as claimed in claim 2, wherein an axial length of the longitudinal slot (102s) is 45% of an overall length of housing (102).

18. The vent apparatus (100) as claimed in claim 1, wherein an insertion kilogram force on said plunger (104) while inserting inside said housing (102) is in the range of 2.5-6.3 kgf.

19. The vent apparatus (100) as claimed in claim 1, wherein insertion kilogram force on said plunger (104) while inserting inside said housing (102) is in the range of 4-5 kgf.

20. The vent apparatus (100) as claimed in claim 18, wherein an extraction kilogram force of said plunger (104) from said housing (102) is in the range of 8.5-15.7 kgf.

21. The vent apparatus (100) as claimed in claim 19, wherein an extraction kilogram force of said plunger (104) from said housing (102) is in the range of 11-13 kgf.

22. The vent apparatus (100) as claimed in claim 2, wherein said biasing mechanism (105) is provided outside said housing (102).

23. The vent apparatus (100) as claimed in claim 22, wherein said biasing mechanism (105) is an elastic band attached to the second portion (102b) of said housing (102).

24. The vent apparatus (100) as claimed in claim 22, wherein said biasing mechanism includes an electro magnet disposed near the second portion (102b) of said housing (102) and a sensor provided on said first portion (104a) of the plunger (104).

25. The vent apparatus (100) as claimed in 4, wherein said biasing mechanism includes an electro magnet disposed near the second portion (102b) of said housing (102) and a sensor provided on said first portion (104a) of the plunger (104).

26. The vent apparatus (100) as claimed in claim 24, wherein said first portion (104a) of said plunger (104) defines a plurality of grooves (G).

27. A vent apparatus (200), said apparatus (200) comprising:
a housing (202) having a first portion (202a), a second portion (202b) provided opposite to said first portion and a middle portion (202m) located between said first portion (202a) and said second portion (202b);
a plunger (204) having a first portion (204a) and a second portion (204b); and
a biasing mechanism (205) extending from said middle portion (202m) towards said first portion (202a) of said housing 202.

28. The vent apparatus (200) as claimed in claim 27, wherein said biasing member (205) defines at least one opening therein to allow fluid passage.

29. The vent apparatus (200) as claimed in claim 28, wherein the second portion (204b) of the plunger (204) is adapted to be disposed above said middle portion (202m) of said housing 202.

30. The vent apparatus (200) as claimed in claim 28, wherein the first portion (204a) and the second portion (204b) of the plunger (204) is always disposed above said middle portion (202m) and near to said first portion (202a) of the housing (202).

31. A vent apparatus (300), said apparatus comprising:
a housing (302) having a first portion (302a), a second portion (302b) and a collar (302c);
a disc (304) disposed near the first portion (302a) of said housing (302);
a bush (306) provided near the second portion (302b) of the housing (302); and
a spring (305), said spring adapted to moveably support the disc (304) and connected to said bush (306).

32. The vent apparatus (300) as claimed in claim 31, wherein said bush (306) defines an opening which is concentric to an opening defined by the collar (302c) of the housing (302).

33. The vent apparatus (300) as claimed in claim 32, wherein said disc (304) is always disposed near the first portion (302a) of said housing (302).

34. A vent apparatus (700), said apparatus comprising:
a housing (702) having a first portion (702a) and a second portion (702b); and
a frame (704a) defining a mesh (704b), said frame (704a) adapted to be received inside the first portion (702a) of the housing (702), wherein
the mesh defines a plurality of grids therein.

35. The vent apparatus (700) as claimed in claim 34, wherein the grid size is in the range of 0.1 mm×0.1 mm to 0.3 mm×0.3 mm.

36. A method of venting air in a rubber molding application, said method comprising:
providing a vent apparatus 100 in a transfer pot 1150 in fluid communication with a rubber mold, wherein, a plunger 104 of said vent apparatus 100 is in an open position initially, where air is allowed pass through said vent apparatus 100 to outside of the rubber mold;
filling molten rubber inside the rubber mold;
cooling the molten rubber;
passing air from outside the rubber mold into the transfer pot 1150 and into a portion of the mold via the vent apparatus 100, thereby preventing a vacuum lock between the transfer pot 1150 and the rubber mold; and
removing the rubber mold.

37. The method as claimed in claim 36, wherein air is passed outside of the rubber mold through the slot 1150s of the transfer pot 1150.

38. The method as claimed in claim 36, wherein air is passed from outside of the rubber mold to the transfer pot 1150 through the slot 1150s defined by the transfer pot 1150.
